(19) United States
(12) Patent Application Publication
(10) Pub. No.: US 2004/0229116 A1
(43) Pub. Date: Nov. 18, 2004

(54) Perforated separator for an electrochemical cell

(76) Inventors: James Andrew Malinski, Madison, WI (US); Chris Alan Garber, Lodi, WI (US); William C. Bushong, Madison, WI (US); Gregory S. Moy, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 10/751,149

(22) Filed: Jan. 2, 2004

Related U.S. Application Data
(63) Continuation-in-part of application No. 10/156,326, filed on May 24, 2002.
(60) Provisional application No. 60/437,977, filed on Jan. 3, 2003.

(51) Int. Cl. H01M 2/16

(52) U.S. Cl. 429/144; 429/253; 29/623.1

(57) ABSTRACT

An electrochemical cell is presented having an improved separator disposed at the interface of the anode and cathode. In particular, the separator includes one or more windings of perforated fabric. A conformal separator coating is applied to the fabric and those portions of the cathode that are radially aligned with the apertures. The conformal separator may be formed from combinations of certain polymers and inorganic crosslinking agents.

### CROSS-REFERENCE TO RELATED APPLICATIONS

The present application is a continuation-in-part of U.S. patent application Ser. No. 10/156,326 filed on May 24, 2002, and further claims priority to U.S. Provisional Patent Application Ser. No. 60/437,977 filed Jan. 3, 2003, the disclosure of which is hereby incorporated by reference as if set forth in its entirety herein.

### STATEMENT REGARDING FEDERALLY SPONSORED RESEARCH OR DEVELOPMENT

### BACKGROUND OF THE INVENTION

The present invention relates to electrochemical cells, and in particular, relates to separators usable in zinc air and alkaline cells and further relates to methods to apply such separators.

Conventional electrochemical cells, such as alkaline cells, comprise a cathode which is a mixture of manganese dioxide, MnO₂, and a carbonaceous material, typically graphite. In some cylindrical alkaline cells, this cathode mixture, which is often wetted with an alkaline electrolyte, is compressed into annular rings. The cathode is then placed into a metal container, which then serves as the positive current collector. An anode, which generally comprises a powdered zinc disposed in a gel, such as carboxymethylcellulose, is also placed into the metal container. A negative current collector, usually a brass pin or nail, is placed in electrical contact with the anode.

In order for the cell to operate, electrolyte must transfer between the anode and cathode. However, if the anode and cathode are not electrically isolated, a short circuit will cause the open circuit voltage of the cell to decrease rapidly, thereby causing the cell to fail prematurely. The electrolyte transfer and electrical isolation are conventionally achieved using an annular separator (in cylindrical cells) that is disposed at the interface between the anode and cathode. Separators typically comprise a non-woven, inert fabric that has sufficient porosity to enable permeability to gas and liquid such as an electrolyte, but substantially solid so as to prevent the cathode from electrically shorting with the anode.

The fabric is typically greater than 0.1 mm thick and often more than one layer is required. In fact, two layers of double-wound fabric are conventionally used. Such separators have a relatively large thickness and thus occupy a significant volume within the cell that could otherwise be occupied by active cell ingredients, which would result in greater performance by the cell. Fabrics of lesser thickness are susceptible to tearing and are thus impractical for use during fabrication of the cell. What has been historically needed therefore is a separator that achieves electrical isolation while permitting electrolyte transfer and that occupies less volume within the cell.

One method used to overcome the limitations of sheet separators is to apply a material or mixture of materials in a carrier directly to the electrodes of an electrochemical cell. The resulting compound thus conforms to the shape of the electrode, thus eliminating air pockets that are associated with annular cloth separators, and is additionally thinner than traditional cloth separators. Accordingly, more internal volume may be occupied by active cell ingredients.

Currently, these compounds may comprise cellulose fibers and soluble cellulose polymers disposed in a solvent carrier. Other methods use a copolymer with a plasticizer onto an electrode element to produce a separator film. Still other methods apply a suspension of inorganic material in a carrier containing a polymer binder. One significant disadvantage of these methods is the carrier solvents or plasticizers which must be removed or displaced with electrolyte in order to produce a functioning separator film that facilitates electrolyte transfer.

Yet other known methods use a polymer coating that is applied to the electrode to form the separator. However, these polymers must be cured or solidified in some manner, such as by allowing a polymer solution with a high melting point to cool or drying the polymer solution, both of which consume time and resources, thereby creating inefficiencies in the fabrication process. Alternatively, polymerization is achieved by combining monomers or oligomers with a polymerization initiator and exposing the mixture to heat or a radiation source, such as ultraviolet light or γ-radiation, thereby also creating inefficiencies. Alternatively, crosslinking is currently accomplished using an organic cross linking agent that creates a solid polymer film. However, organic crosslinking agents, such as divinyl sulfone, are toxic and hazardous to handle.

What is therefore needed is an improved separator for an electrochemical cell that is nontoxic and efficient to manufacture, thus avoiding the disadvantages associated with current methods.

### BRIEF SUMMARY OF THE INVENTION

In accordance with one aspect, the invention provides an electrochemical cell having a container and a cathode material disposed in the container. An anode material is disposed in the container adjacent the cathode, and a separator disposed between the cathode and the anode. The separator includes a fabric presenting an anode-facing surface, and a conformal coating disposed on the anode-facing surface formed from a polymer and a crosslinking agent. The separator prohibits electrical contact between the anode and cathode while permitting electrolyte transfer between the anode and cathode.

In one form, the crosslinking agent is inorganic. In another form, the fabric presents a plurality of apertures extending therethrough to expose an inner surface of the cathode. The conformal coating further covers the inner surface.

These and other aspects of the invention are not intended to define the scope of the invention for which purpose claims are provided. In the following description, reference is made to the accompanying drawings, which form a part hereof, and in which there is shown by way of illustration, and not limitation, preferred embodiments of the invention. Such embodiments do not define the scope of the invention and reference must be made therefore to the claims for this purpose.

### BRIEF DESCRIPTION OF THE DRAWINGS

Reference is hereby made to the following figures in which like reference numerals correspond to like elements throughout, and in which:

FIG. 1 is a sectional side elevation view of a cylindrical electrochemical cell having a separator constructed in accordance with the preferred embodiment;

FIG. 2 is a sectional side elevation view of a metal-air cell having a separator constructed in accordance with the preferred embodiment;

FIG. 3 is a side elevation view of a perforated separator fabric constructed in accordance with the preferred embodiment;

FIG. 4 is a side elevation view of a perforated separator fabric constructed in accordance with an alternate embodiment;

FIG. 5 is a schematic perspective view of the perforated separator fabric illustrated in FIG. 3 being installed during fabrication of a cell;

FIG. 6 is a sectional side elevation view of an electrolyte being added to the partially assembled cell illustrated in FIG. 5;

FIG. 7 is an exploded sectional side elevation view of the positive terminal end of the cell illustrated in FIG. 6 taken along the line 7-7;

FIG. 8 is a sectional side elevation view of a conformal separator material being applied to the cell illustrated in FIG. 7; and

FIG. 9 is an exploded sectional side elevation view of the cell illustrated in FIG. 8 taken along the line 9-9.

### DETAILED DESCRIPTION OF THE PREFERRED EMBODIMENT

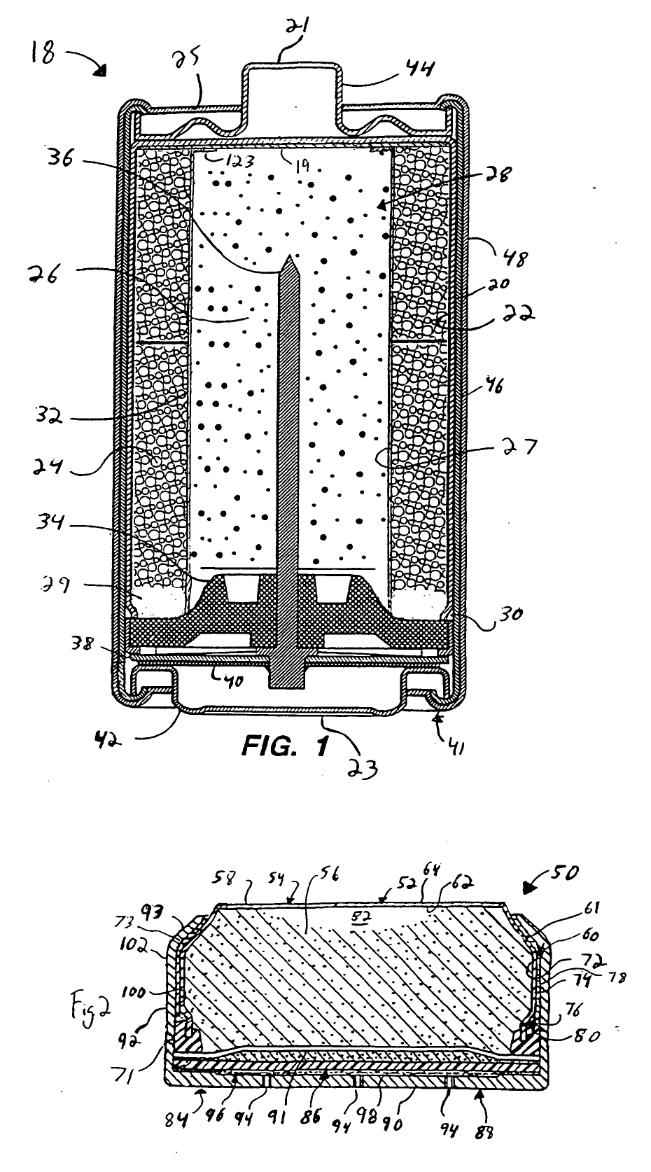

Referring initially to FIG. 1, an axially extending cylindrical cell 18 constructed in accordance with a preferred embodiment of the present invention is illustrated having a positive terminal 21, a negative terminal 23, and a positive current collector in the form of an unplated cylindrical steel container 20. Container 20 is initially closed at its positive end 25 proximal the positive terminal 21 and open at its end proximal the negative terminal 23 such that the negative end of container is crimped to close the cell 18 as is understood generally by a skilled artisan.

At least one or more cylindrical annular cathode rings 24, formed such that their outside diameters at their outer peripheral sidewalls are greater than the inside diameter of the positive current collector 20, are forced into the positive current collector. A coating 22, preferably carbon, is applied to the radially inner surface of container 20 to enhance the electrical contact between the cathode rings 24 and the container. Installation of the cathode rings 24 forms a pressure contact with the coating 22. Cathode 24 further presents an inner surface 27 that define a centrally shaped void 28 in a cylindrical cell within which anode 26 is disposed.

A cylindrical disk 19 of non-woven fabric extends inwardly from container 20 proximal the positive end 25, and provides a separator between the anode 26 and container 20 while preventing leakage between the anode 26 and cathode 24. Disk 19 further provides structural support for cathode 24, and partially defines an active region of cell 18. Alternatively, disk 19 could have a diameter that is substantially equal to (or slightly greater than) the inner diameter of cathode rings 24 to provide a barrier between anode 26 and cathode 24. A bead 30 is rolled into the container near the negative end 41 to support a sealing disk 34 as will be described below. It should be appreciated that cathode 24 can terminate short of disk 34, such that a void 29 is disposed between the portion of cathode 24 proximal negative terminal 23 and disk 34. Anode 26, which is placed inside of the cathode rings 24, is generally cylindrically shaped, and has an outer peripheral surface which engages the inner surfaces of a separator 32, and comprises gelled zinc in accordance with the preferred embodiment. Separator is disposed adjacent inner wall 27 between the cathode 24 and anode 26.

The sealing disk 34, having a negative current collector 36 extending therethrough, is placed into the open end of the container 20 and in contact with the bead 30. The negative open end 41 of the container 20 is crimped over the sealing disk 34 thus compressing it between the crimp and the bead 30 to close and seal the cell. An insulation washer 38 with a central aperture is placed over the crimped end of the cell such that the end of the negative current collector 36 protrudes through the aperture. A contact spring 40 is affixed to the end of the negative current collector 36. Negative terminal cap 42 and positive terminal cap 44 are placed into contact with the contact spring 40 and the positive current collector 20, respectively, and an insulating tube 46 and steel shell 48 are placed around the cell 18 and crimped on their ends to hold the terminal caps in place. It should be appreciated that steel shell 48 and insulating tube 46 could be eliminated to increase the internal volume for the cell that may be occupied by active ingredients. Such an arrangement is described in U.S. Pat. No. 5,814,419 assigned to Rayovac Corporation, the disclosure of which is hereby incorporated by reference herein for the purposes of background information. Rayovac primary alkaline cells having no steel shell 48 or insulating tube 46 are commercially identified as LR20 (size “D”) and LR14 (size C) type cells.

Separator 32 is most preferably an ionically permeable separator, and is interposed between anode 26 and the inner peripheral sidewalls of cathode rings 24 to prevent electrical contact between the anode and cathode while permitting ionic transport between anode 26 and the cathode 24. Separator further extends radially across the cell proximal the positive end and between the inner surface of the can 20 and the anode 26. An alkaline aqueous electrolyte typically comprising potassium hydroxide and water at least partially wets anode 26, cathode rings 24, and separator 32. Unlike separators of conventional cells, separator 32 is advantageously a conformal separator formed from a polymer mixed with an inorganic crosslinking agent that occupies significantly less volume than a conventional fabric, thereby providing greater volume for active material, as will be described in more detail below.

Referring to FIG. 2, a button-size metal-air cell 50 constructed in accordance with the preferred embodiment includes a negative electrode 52 (anode), and corresponding anode can 54 having an electrolyte with anode material 56 disposed therein. In accordance with the preferred embodiment, the anode can material comprises tri-clad copper-steel-nickel, though it should be easily understood by one having ordinary skill in the art that any well known anode material could be used, such as beryillium copper, stainless steel, copper, nickel, or a combination thereof.

Anode can 54 has a top wall 58, and an annular side wall 60 extending axially downwardly from its periphery. Top wall 58 includes an inner surface 62 and outer surface 64. Side wall 60 has an inner surface 72 and an outer surface 74, and further includes an edge region 76 remote from top wall 58, and intermediate region 78 between edge region 76 and top wall 58. An upper region 61 is disposed between top wall 58 and intermediate region 78, and prevents a beveled surface with respect thereto. Edge region 76 is generally defined as that portion of side wall 60 which is displaced radially inwardly of, and axially downstream of, region 78. Remote region 76 terminates at a distal end 80, which is located at the bottom edge of side wall 60. Side wall 60 presents a beveled edge at region 76 that joins region 78 to distal end 80, which extends axially upstream therefrom. Top wall 58 and side wall 60 collectively define an open cavity 82 that contains the anode material 56.

The cell further includes a positive electrode (cathode 84), that is defined by a cathode assembly 86, including a cathode mixture and current collector that is contained within a cathode can 88 to enclose cavity 82. Cathode can 88 comprises nickel plated steel in accordance with the preferred embodiment, and has a base 90, and an annular side wall 92 extending axially upwardly from bottom 90. Side wall 92 extends past the remote region 76 of anode side wall 60 so as to produce an outer structure that enables the cell to be inserted into conventional button cell cavities for use. Annular side wall 92 defines an upper beveled edge 93 that mates with the upper region of anode can 54. Side wall 92 includes an outer surface 102 and an inner surface 100 that faces outer surface 74 of anode can 54. A plurality of air ports 94 extend through bottom 90 of the cathode can, thereby providing avenues for the transport of oxygen into the cell adjacent the cathode assembly 86. An air reservoir 96 spaces the cathode assembly 86 from the bottom 90 and the corresponding ports 94. A porous air diffusion layer 98 fills the air reservoir 96, and comprises Teflon in accordance with the preferred embodiment. It should be appreciated that layer 98 may either be independent of, or integral with, the cathode assembly 86. The cathode 84 presents a surface that interfaces with the anode 52.

An insulating member 73 is disposed between the inner surface 100 of side wall 92 and outer surface 74 of side wall 60 at the intermediate region 78 and upper region 61 to provide electrical isolation between the anode can 54 and cathode can 58. In particular, insulator 73 is disposed axially upstream of the remote edge region, where the side walls 60 and 92 are in close proximity so as to require electrical isolation. Insulator 73 may comprise any suitable material well known in the art, such as propylene, cellulose, paper, waxed paper, or could comprise Teflon that is applied to the outer surface 74 of side wall 60, or inner surface 100 of side wall 92 to form a coating thereon. Insulator 73 has a small thickness, thereby permitting an increased volume for active material within container 52 as compared to conventional button cells.

The cathode 84 and anode 52 are further electrically isolated from one another via a radially compressed seal (hereinafter also referred to as “radial seal”) that is disposed proximal the remote edge region 76. The seal extends substantially along the side wall of the anode can at the remote region 76 to further prevent leakage of electrolyte. The seal is accomplished via an insulating gasket 71 that comprises nylon 6,6 in accordance with the preferred embodiment, but could alternatively comprise other suitable materials that are capable of providing the requisite insulation as well as the seal.

A separator 91 is disposed at the interface between the anode 52 and the anode-facing surface of cathode assembly 86. Separator 91 permits electrolyte transfer therebetween while providing electrical isolation therebetween. Separator 91 conventionally comprises a non-woven, inert fabric that has sufficient porosity to enable permeability to gas and liquid such as an electrolyte, but substantially solid so as to prevent the cathode from electrically shorting with the anode. In accordance with the preferred embodiment, separator 91 is a conformal separator formed from a polymer mixed with an inorganic crosslinking agent that occupies significantly less volume than a conventional fabric, thereby providing greater volume for active material.

In the description below, while the separator discussed below will refer to separator 32 of FIG. 1, the principles of the present invention are equally applicable to separator 91 of FIG. 2 along with separators of any suitable alternative cells. It should be further appreciated that, throughout the description, though reference numerals are used to correspond to cell components of either the cylindrical cell of FIG. 1 or the metal-air cell of FIG. 2, such reference numerals are used for the purposes of clarity and convenience, and not to limit any particular embodiment of the present invention to the type of cell corresponding to the reference numerals used. Therefore, unless explicitly stated otherwise, the description below along with the following examples are applicable to both cylindrical cells and metal-air cells. It should be further appreciated that while a skilled artisan may recognize the cylindrical cell illustrated in FIG. 1 as a size AA cell of bobbin construction, the present invention is applicable to any size cylindrical cell of bobbin or spiral wound construction, including but not exclusive to Size AAA, C, D, and 9-Volt cells. The present invention is further applicable to any size metal-air cell including button cells.

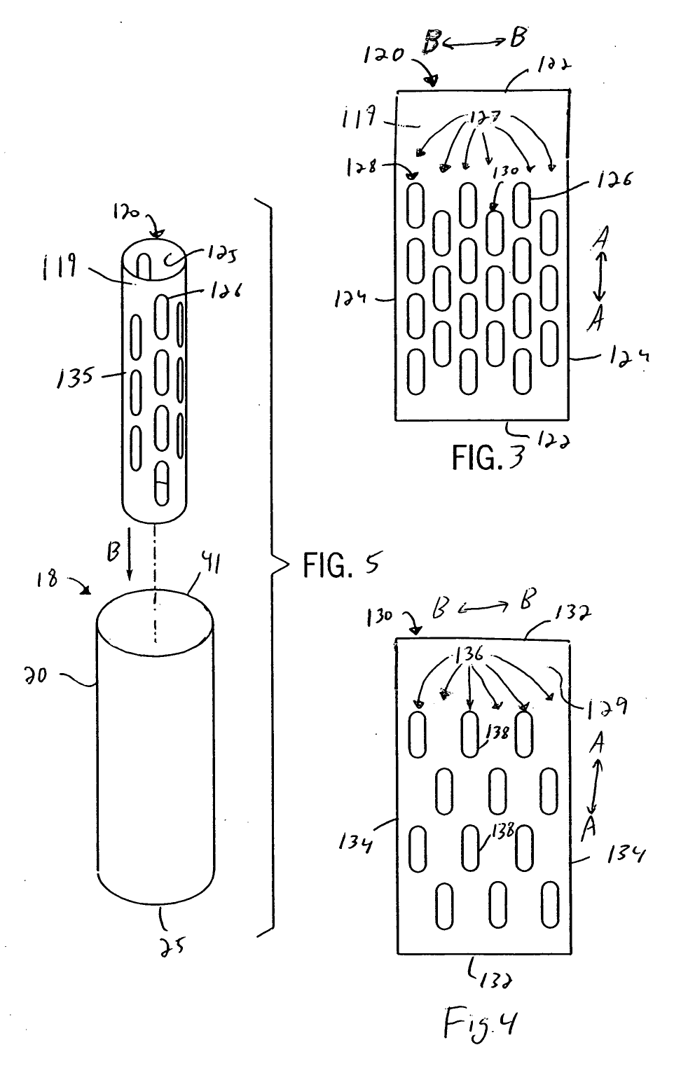

Referring now to FIGS. 3-9, it has been found that separator 32 may be constructed in accordance with the preferred embodiment as a hybrid using a combination of perforated non-woven fabric 120 in combination with a conformal separator coating 150. One skilled in the art will appreciate that the term “perforated” is referred to herein with reference to a separator substrate having pores sufficiently large to enable zinc gel to migrate into the cathode but for the conformal coating 150 covering the perforations to prevent such migration. One skilled in the art will appreciate that the term “perforated” need not require that a secondary process be performed on the substrate to create the pores. For instance, the perforations may refer to natural pores that exist in manufactured woven and non-woven fabrics.

While coating 150 could comprise any conformal separator known in the art, the coating used in accordance with the preferred embodiment is a mixture of certain polymers and inorganic crosslinking agents. Additionally, the combinations employed in accordance with the preferred embodiment eliminate the need to use heat, light, radiation or hazardous organic crosslinking agents that are used in conventional methods for coating electrodes, as discussed above.

Referring to FIGS. 3 in particular, a non-woven fabric 120 includes opposing sets of laterally extending edges 122 and longitudinally extending edges 124 that define a generally rectangular shape and is sized to be installed into a size AA cell. The laterally extending edges 122 should have a length slightly greater than the circumference of the inner annular surface 27 of cathode 24. The longitudinally extending edges 124 should have a length slightly greater than the axial length of the annular inner surface 27 presented by cathode rings 24 to ensure that the separator 32 extends beyond the cathode 24 which will minimize the risk of shorting the cell. When installed in a AA size cell, the length of edges 122 is approximately 1.21 while the length of edges 124 is approximately 1.90 in. While many fabrics may be used in accordance with the present invention, the preferred embodiment contemplates using the F3R31, which is commercially available from Kurray, located in Osaka, Japan. Fabric 120 is preferably a single wrap (or alternatively a double wrap) of F3R23, having a thickness of approximately 0.08 mm per wrap, though it should be appreciated that the material and thickness may differ. It is generally desirable for fabric 120 to comprise a stiff material to enable sufficient rigidity to enable cell assembly while minimizing the thickness to maximize the internal volume of the cell available for active cell components.

A plurality of columns 127 of elongated generally oval-shaped apertures 126 extends longitudinally through fabric 120, though it should be appreciated that the apertures could comprise any suitable size and shape. Adjacent columns 127 are offset with respect to the longitudinal direction A<-->A to enable electrolyte to penetrate the cathode 24 in a diffuse manner, as will become more apparent from the description below. In the illustrated embodiment, the offset is less than the longitudinal distance of each aperture 126, such that apertures in adjacent columns overlap each other with respect to the lateral direction B<-->B. A total of twenty-one apertures 126 extend through fabric 120 and are arranged in six longitudinal columns of apertures, each column including apertures aligned in the longitudinal direction. The columns alternate between those defining four apertures 128 and three apertures 130. It should be appreciated that the apertures 126 could alternatively be offset with respect to the lateral direction B<-->B and aligned in the longitudinal direction A<-->A, or staggered in both the lateral and longitudinal directions. Fabric 120 further includes an upper margin 119 that lacks any perforations. Margin 119 preferably extends longitudinally downwardly from edge 122 a sufficient distance to slightly overlap void 29, along with that portion of cathode 24 that is disposed immediately proximal void 29, to prevent zinc particles from migrating into contact with cathode 24.

Referring to FIG. 4, an alternative non-woven fabric 130 includes opposing sets of laterally extending edges 132 and longitudinally extending edges 134 that define a generally rectangular shape having an upper margin 129. Fabric 130 is generally of the same size and shape as fabric 120, but has six longitudinally aligned columns 136, each column defining two apertures 138. Columns 136 define apertures 138 that are offset in the longitudinal direction A<-->A with respect to apertures 138 of adjacent columns. The degree of offset is greater than (or could alternatively be equal to) the longitudinal distance of the apertures 136 such that apertures of adjacent columns do not overlap in the lateral direction B<-->B. Apertures 138 are thus more dispersed in the fabric 130 than apertures 126 of fabric 120, thereby rendering fabric 120 more porous than fabric 130 when fabricated of like material. It will be appreciated from the description below that a greater number of apertures increases the active volume of the cell, while fewer apertures increases the stiffness of the separator.

The assembly of separator 32 is illustrated with reference to FIGS. 5-9. Referring initially to FIG. 5, non-woven fabric 120 is placed inside a partially fabricated cell 18. First, however, fabric 120 is rolled into an elongated longitudinally extending cylinder such that opposing edges 124 are brought towards each other and slightly overlap. It is desirable for edges 124 to overlap slightly to ensure that fabric 120 presents a continuous inner annular surface 125. However, the amount of overlap should be minimal, it being appreciated that the area of overlap presents a double-wound thickness that correspondingly reduces the internal volume for active cell ingredients. In accordance with the preferred embodiment, edges 124 overlap by approximately ⅛ inch.

The cylindrical fabric 120 is then installed in the partially assembled cell 18 along the direction of Arrow B. In particular, the current collector 20 is provided, and the insulating tube 46 and steel shell 48 are placed around the current collector 20, which is then crimped at the positive end 25 prior to insertion of fabric 120. The negative end 41 remains open for the installation of cell components, and current collector is oriented with negative end 41 facing up. Plate 19 is then installed in the cell, followed by cathode rings 24. It should be appreciated that plate can be installed after the cathode 24 if the plate has a diameter substantially equal to the inner diameter of cathode rings. The cylindrical non-woven fabric 120 is then inserted into the void 28 of container 20 such that its radially outer surface 135 abuts the inner surface 27 of cathode 24. Because the length of fabric 120 in the axial direction is greater than that of void 28, a portion 123 of the fabric 120 extends radially inwardly at the positive end of the cell 18. Radial portion 123 further prevents anode material 26 from seeping into the cathode 24.

It should be appreciated that a secondary piece of nonwoven and nonperforated fabric (not shown) in the shape of a cup can be installed into the cell proximal the positive end 21. Specifically, the cup can include a bottom surrounded by an annular wall extending outwardly from the bottom. The cup can be installed before separator 32 such that the outer surface of the bottom rests against plate 19, and the annular wall abuts the inner surface of cathode 24. Alternatively, the cup can be installed after separator 32, in which case the outer surface of the cup would abut the inner surface of separator 32. Installation of such a cup will further isolate cathode 24 from zinc particles in the arnode 26.

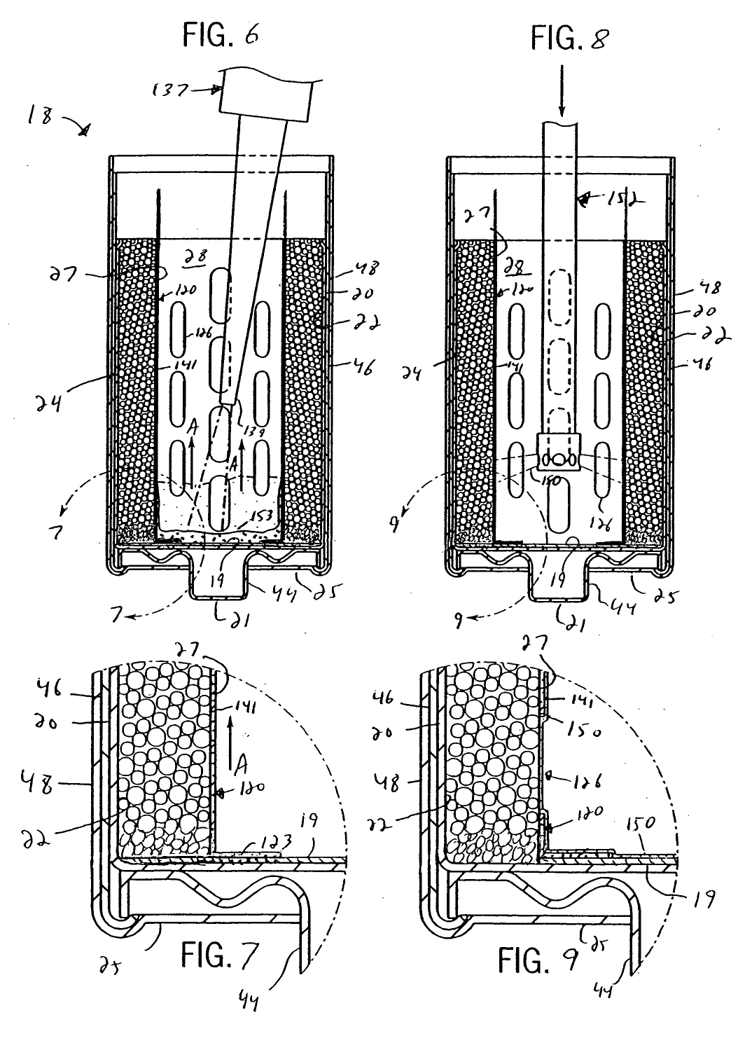

Referring now to FIG. 6, the cathode 24 and fabric 120 are next pre-wetted with electrolyte to induce PH crosslinking, though one skilled in the art should appreciate that the separator may be prepared before introducing electrolyte. In accordance with the preferred embodiment, a conventional dropper 137, or the like, is filled with a predetermined volume of electrolyte material KOH 153. The dispensing end 139 of the dropper 137 is then inserted into the void 28 and the KOH is dispensed into the cell 18. Due to the orientation of the cell 18, the KOH pools at the positive end of the void 28 such that the positive end of fabric 120 becomes immersed in electrolyte.

Referring now also to FIG. 7, the electrolyte 153 wicks up the remainder of fabric 120 in the direction of Arrow A. As fabric 120 becomes immersed with electrolyte, the electrolyte is also absorbed by the cathode 24. It should be appreciated that the view illustrated in FIG. 7 of the fabric 120 is taken at a location not occupied by an aperture 126 to clearly illustrate the wicking, it being appreciated that the KOH does directly not wick up through each aperture 126. Rather, the electrolyte wicks axially up the fabric 120 and around each aperture 126. That portion of the electrolyte seeps radially inwardly into the cathode 24. The apertures 126 therefore prevent electrolyte from seeping directly into the cathode at locations aligned with the apertures.

However, the apertures 126 are advantageously elongated in the axial direction of electrolyte travel (Arrow A), are narrow in a direction transverse to Arrow A, and furthermore are staggered with respect to the transverse direction. Accordingly, the electrolyte located proximal the elongated edges of each aperture 126 is able to disperse in the transverse direction to become absorbed by cathode 24 even at portions aligned with the apertures 126. This process continues until the fabric 120 becomes saturated with electrolyte, and a sufficient amount of electrolyte has been absorbed by the cathode 24. In accordance with the preferred embodiment, 1.30 grams of electrolyte is injected into the void 28 a size AA cell. All electrolyte is absorbed in approximately 10 minutes.

In conventional cell fabrication techniques, a conventional nonwoven separator is installed immediately after the cathode, and the separator is then pre-wetted with electrolyte. Because the separator has low porosity to air, especially when wetted with electrolyte, air entrapped between the cathode and the separator is unable to readily escape through the separator, thereby retarding in-cell reactions during cell operation. If the cathode is pre-wetted with electrolyte prior to installing the separator, the separator tends to stick to the wet cathode during insertion, thereby rendering the fabrication process tedious and labor-intensive.

Advantageously, the fabrication process described in accordance with the preferred embodiment enables the electrolyte to force air entrapped between the cathode 24 and fabric 120 through the fabric perforations at a rate higher than conventionally achieved due to the increased porosity provided by the perforations with respect to conventional non-woven fabrics, at which point the air enters cavity 28 and escapes the cell via open end 41. Accordingly, once the coating 150 is applied to fabric 120 (as is described in more detail below), and the remainder of the cell components installed in the usual manner, the cell 18 can begin operation with less air entrapped between the cathode 24 and separator 32 compared to conventional cells. It should be further appreciated that the absorption of the electrolyte into the cathode 24 during fabrication further displaces air that may be entrapped in the cathode. The displaced air then travels more rapidly through the fabric perforations compared to conventional cells, and escapes out the open end 41.

It should be appreciated that a single winding of fabric 120 by itself will not likely provide a sufficient barrier to contact between the anode and cathode. Furthermore, anode and cathode would likely contact each other through the apertures 126. One significant function of separator 32 is to maintain electrical isolation between the anode 26 and cathode 24. Otherwise, the resulting short circuit will cause the open circuit voltage (OCV) of the cell to decrease rapidly, thereby causing the cell to fail prematurely. damaging the cell 18.

Accordingly, referring now to FIGS. 8 and 9, a conformal separator coating 150 is applied to the radially inner, anode-facing surface 141 of fabric 120. In addition, or alternatively, coating 150 could be applied to the outer, cathode-facing surface of fabric 20 and/or to the inner anode-facing surface of cathode 24 prior to the insertion of fabric 120. The fabric 120 after insertion into void 27 remains taller than cathode 24, thereby allowing head space for expansion of anode and/or cathode upward and preventing shorting on top of cathode 24. Coating also covers the cathode 24 at locations radially aligned with apertures 126. It will be appreciated that the fabric 120 adds structure to the separator 32, absorbs additional electrolyte, may be manufactured thinner than conventional non-woven fabric separators, and has apertures 126 that in combination increase the volume of active material in the cell. The coating 150 is preferably applied using a Nordson MEG™ electric spray gun 152 controlled by an EPC-15 system controller (not shown) and pressurized with a CP high pressure pump (not shown) all available from Nordson Corporation, located in Amherst, Ohio. Alternatively, the coating could be injected into the cell 18 to fill the void 28 and subsequently removed leaving a conformal film on the inner surface 141 of fabric 120 and those portions of the inner surface 27 of cathode 46 that are aligned with the apertures 126. The spray gun 152 is preferred as the thickness and uniformity of coating 150 may be more easily controlled.

The present invention recognizes that when a crosslinkable polymer is mixed with an inorganic crosslinking agent (such as any borate derivative), a rapid reaction ensues and results in the production of a compound having properties suitable to prohibit electrical contact between the anode and cathode of an electrochemical cell while enabling ionic transport therebetween. In particular, a material containing a plurality of hyroxyl groups, such as a vinyl alcohol, and preferably a fully (e.g., >85%) hydrolyzed polyvinyl alcohol (PVA) solution, is mixed with an inorganic solution containing a borate derivative. The ensuing rapid reaction produces borate-binding polyvinyl chains. In accordance with the preferred embodiment, the borate derivative, for example potassium borate, sodium borate, or zinc borate is crosslinked with polyvinyl alcohol that is at least partially hydrolyzed to render the compound insoluble in alkaline electrolyte. The PVA preferably has a concentration anywhere between 0.5% and 12%, and the borate preferably has a concentration up to 5% while remaining soluble in the PVA solution, though one skilled in the art will recognize that these concentrations may differ without departing from the present invention. It has been found that adding between 0.3 and 0.6 gram (and preferably approximately 0.5 gram) of PVA (having between 1.15% and 2% concentration) and boric acid having between 0.5% and 5% (and preferably approximately 2%) concentration produces an functional and reliable separator 32.

Preferably, the crosslinking agent and polymer are premixed, and the mixture is applied to the anode-facing surface 141 of the fabric 120 to produce separator 32. Alternatively, the coating may be formed by first applying the crosslinking agent to the anode-facing surface 141 of the fabric 120, and subsequently applying the polymer to trigger the crosslinking reaction that produces usable separator 32. In accordance with one embodiment, the polymer is in the form of polyvinyl alcohol preferably having an average molecular weight greater than 13,000 and less than 500,000. In accordance with another embodiment, the weight ratio between the borate derivative and the vinyl alcohol is preferably between 1:1000 and 1:1.

In accordance with another embodiment, the borate derivative is boric acid that is combined with a polymer, such as polyvinyl alcohol. The resulting mixture is further combined with a base solution electrolyte, such as KOH to trigger the crosslinking reaction. The use of boric acid may be desirable in some instances as it may be pre-mixed with the polymer (e.g., PVA) to form a non-reacting mixture, and subsequently sprayed onto the anode-facing surface 141 of the fabric 120. The pre-wetting of fabric 120 with electrolyte may be used to immediately commence the crosslinking reaction, or additional electrolyte may be added after the mixture is applied to the fabric. Of course, the boric acid may be applied to the fabric 120 separate from the polymer if desired. While a boric acid is used in accordance with this embodiment, it should be appreciated that the properties that allow it to cross-link the alcohol are inherent to other compounds falling under the general designation of a Lewis acid, which have an affinity for lone pairs of electrons. Because PVA is an electron donor, it binds in the presence of borate. Electron donors such as PVA are recognized as Lewis bases. While Boron-based compounds and PVA are used in accordance with the preferred embodiment, it should be appreciated that alternative Lewis acids and Lewis bases may be used to provide a conformal coating for separator 32 having the advantages associated with the present invention, borate and PVA being included within their respective genus.

A large variety of polyvinyl alcohol polymers may be used in the preferred embodiment of this invention including but not limited to those described in U.S. Pat. No. 5,057,570, which is hereby incorporated by reference, and those sold by Celanese Chemicals. The weight average molecular weights of the employed polymers may be narrowly distributed, broadly distributed or bimodally distributed. Other polymers, such as guar gum and guar gum derivatives, copolymers of polyvinyl alcohol, or other polymeric materials with hydroxyl functional groups may be used in place of the polyvinyl alcohol and crosslinked with borate derivatives, including borate, boric acid and derivatives thereof, and boric acid esters (also named in IUPAC convention system as triallkyloxyboranes and triaryloxyboranes) including also cyclic boric acid esters and such borate esters as DeCORE BE-85 sold by DeForest Enterprises in Boca Raton, Fla. or other inorganic ions, as appreciated by those having ordinary skill in the art.

When a borate ester is used, the borate will normally crosslink without the organic portion of the ester being incorporated as part of the crosslinked network following a complete hydrolysis of the starting borate ester. Accordingly, the product of the crosslink includes the borate and not the organic portion of the borate ester. In other cases, if the borate ester has the organic portion built into the crosslinked portion of the gel, the crosslinking occurs through the borate moiety. Accordingly, in both cases, the crosslinking agent is inorganic in accordance with the present invention.

It is also foreseen that commercially available PVA/boric acid derived products such as Celvol MH-82, MM-81, MM-51 and MM-14 can also be successfully applied as chemical components in the present invention having particular economic and manufacturing advantages. Furthermore, the borate solution may alternatively be substituted by compounds that form borate in aqueous solutions, such as BCl₃ or other halogenated compounds. This resulting reaction produces a strong polymer gel matrix. Moreover, because borate and polyvinyl alcohol are both safe to handle, the fabrication process is simplified compared to conventional conformal separator coatings.

In accordance with yet another alternate embodiment, a di-alcohol is mixed with a borate derivative (e.g., sodium borate, potassium borate, zinc borate) to produce a polymerization reaction that produces a network polymer suitable for use as a conformal separator. Alternatively, the di-alcohol could be mixed with boric acid to facilitate application of the material with the crosslinking reaction proceeding upon the solution coming into the presence of electrolyte of alkaline solution.

Once the fabrication of separator 32 is complete, the anode (i.e., zinc) is added to the void 28, and the negative end of the cell 18 is assembled to complete the assembly of the cell. The separator 32 thus produced in accordance with all of the above embodiments has been found to be stable in electrolyte over a long period of time even at high temperatures. Furthermore, the separator 32 has a porosity that is sufficient to enable a high degree of ionic conductivity between anode 26 and cathode 24, and furthermore achieves electrical isolation between the electrodes. One skilled in the art would also recognize that the electrolyte could contain additives of various types for various purposes. Common additives would be of the variety used to suppress gas generation in the anode of the cell. Other additives to the electrolyte could include but would not be limited to chemical agents that promote or accelerate crosslinking as well as soluble or suspendable crosslinking agents.

Various considerations may be made in the construction and manufacturing of the invention. Deciding whether to apply a borate or a boric acid to the cell depends both upon the type of cell and the process used to manufacture it. Those cells that are manufactured in a process where the alkaline electrolyte is placed into the fabric 120 and cathode 46 prior to separator application are amenable to use of boric acid as a crosslinking agent for the separator. It should be appreciated that some cells are designed, or the manufacturing layout of the cell, such that the cell is not easily amenable to pre-wetting the fabric 120 and cathode 46 with electrolyte. Such cells are viable candidates to use borates as crosslinking agents for the conformal coating 150 that is applied to directly to the fabric 120.

Because the thickness of the crosslinking products is less than 0.13 mm (the thickness of two additional wraps of non-woven fabric), the resulting fabric 120 and coating 150 has the stability of the non-woven fabric while creating additional room within the cell for active material than previously achieved using non-woven fabric separators, thereby enhancing the life and performance of the cell. The thickness of separator 32 is further reduced in the area of apertures 126, which are sufficiently small to avoid risking the rupture of coating 150 at those locations. Accordingly, the separator 32 occupies significantly less volume than traditional non-woven, inert fabrics, thereby permitting a greater amount of active material within the cell and improving the cell's performance.

Alternatively, the polymer (PVA) and crosslinking agent may be sprayed in an alternating manner onto the anode-facing surface of the fabric 120. In particular, the chemicals may be sprayed using a compact spray gun such as the Nordson MEG™ electric spray gun controlled by an EPC-15 system controller and pressurized with a CP high pressure pump all available from Nordson Corporation, located in Amherst, Ohio. It has been found that this system is able to spray at a rate of 0.001 g/cm2, thereby producing a very fine layer of the compound being applied. The crosslinking agent and polymer may thus be iteratively sprayed until a minimum necessary thickness is obtained to ensure electrical isolation between the cell electrodes. The repetitious spraying thus enables the production of a conformal separator whose thickness is minimized while maintaining cell stability to maximize the cell contents and further adding to the life and performance of the cell.

While the above examples for fabricating zinc air and alkaline cells incorporating the conformal separator 32 have been described in accordance with the preferred embodiment, the present invention includes alternate embodiments that can enhance the functionality of separator 32. In particular, inorganic ions such as potassium and calcium may be crosslinked with carrageenan and other organic polymers to provide a conformal separator in accordance with the present invention. Even though carrageenan is organic, this fabrication improves upon conventional methods by employing an inorganic crosslinking agent, thereby rendering the fabrication process less hazardous and, consequently, more efficient.

Additionally, structural and/or absorbent filler materials may be added to the conformal separator to provide additional structure and to absorb additional electrolyte, thereby increasing the conductivity of the cell. Examples of absorbent filler materials include polyvinyl alcohol fibers and cellulose fibers, which are also structural materials, while strictly structural filler materials may comprise polymer fibers or other inorganic powders. Pore forming materials, such as zinc oxide and barium sulfate, may be further added to the separator. The pore forming materials react with the electrolyte to produce apertures in the separator that are sufficiently small so as to maintain electrical isolation between the anode and cathode while increasing the conductivity of the cell.

The ionic conductivity of the separator 32 may be further increased by combining the polyvinyl alcohol and borate with anion conducting materials, such as a hydroxide ion, and anion exchange polymers, for example cationic quaternary ammonium ion polymers. These anion conducting materials may assume the form of solid resins, soluble polymers, and polymers copolymerized with the materials that comprise the conformal separator. Conductivity may further be enhanced by adding cationic compounds to the electrode, conformal separator materials, or the electrolyte. For examples, quaternary ammonium ions may be mixed with polyvinyl alcohol, the boric acid, or applied directly to the battery electrode or added to the electrolyte. Conductivity may further be increased by the addition of inorganic materials such as laponite, bentonite or smectite clays, or clay-like materials. Finally, the conductivity may be enhanced by adding inorganic or organic salts, including metal hydroxide salts, into the separator 32. If the salt is soluble, additional pores will be formed in the separator to increase electrolyte flow as described above. If the salt is insoluble, the conductivity of the separator will be increased, as appreciated by those having ordinary skill in the art. The hydroxide salt may be mixed with the polyvinyl alcohol, the borate crosslinking solution, or applied directly to the electrode or added to the electrolyte.

The invention has been described in connection with what are presently considered to be the most practical and preferred embodiments. However, the present invention has been presented by way of illustration and is not intended to be limited to the disclosed embodiments. For instance, the present invention contemplates that any perforated separator that would allow migration of zinc particles into the cathode but for the application of coating 150, including a fabric having open weaves or a non-woven fabric having a pore size large enough to render it otherwise ineffective as a separator, as opposed to a conventional nonwoven fabric separator, could be used in place of the separators disclosed above. Accordingly, those skilled in the art will realize that the invention is intended to encompass all modifications and alternative arrangements included within the spirit and scope of the invention, as set forth by the appended claims.

We Claim:

1. An electrochemical cell comprising:
a container;
a cathode material disposed in the container, wherein the cathode presents an anode-facing surface;
an anode material disposed in the container adjacent the cathode; and
a separator disposed between the cathode and the anode, wherein the separator includes:
i. a perforated fabric presenting an anode-facing surface and a cathode-facing surface; and
ii. a conformal coating applied to at least one of the anode-facing surface, the cathode-facing surface, and the inner cathode surface, wherein the coating is formed from a polymeric material,
wherein the separator prohibits electrical contact between the anode and cathode while permitting electrolyte transfer between the anode and cathode.

2. The electrochemical cell as recited in claim 1, wherein the fabric is non-woven.

3. The electrochemical cell as recited in claim 2, wherein the fabric presents a plurality of apertures extending therethrough to expose an inner surface of the cathode, and wherein the conformal coating covers the inner surface.

4. The electrochemical cell as recited in claim 1, wherein the conformal coating further comprises a crosslinking agent.

5. The electrochemical cell as recited in claim 4, wherein the crosslinking agent is inorganic.

6. The electrochemical cell as recited in claim 5, wherein the crosslinking agent comprises a borate derivative.

7. The electrochemical cell as recited in claim 6, wherein the borate derivative is selected from the group consisting of potassium borate, sodium borate, zinc borate, and boric acid.

8. The electrochemical cell as recited in claim 7, wherein the borate derivative is boric acid.

9. The electrochemical cell as recited in claim 7, wherein the borate derivative is mixed with the polymer and electrolyte.

10. The electrochemical cell as recited in claim 1, wherein the polymer comprises a plurality of hydroxyl groups.

11. The electrochemical cell as recited in claim 10, wherein the polymer is a vinyl alcohol.

12. The electrochemical cell as recited in claim 11, wherein the polymer comprises polyvinyl alcohol.

13. The electrochemical cell as recited in claim 12, wherein the polyvinyl alcohol has an average molecular weight greater than 13,000 and less than 500,000.

14. The electrochemical cell as recited in claim 1, wherein the cell is selected from the group consisting of a cylindrical cell and a metal-air cell.

15. The electrochemical cell as recited in claim 1, wherein the polymer comprises a di-alcohol.

16. The electrochemical cell as recited in claim 1, wherein the polymer is selected from the group consisting of guar gum, guar gum derivatives, copolymers of polyvinyl alcohol, and polymeric materials with hydroxyl functional groups.

17. The electrochemical cell as recited in claim 4, wherein the polymer comprises polyvinyl alcohol and the crosslinking agent comprises a borate derivative, and wherein the weight ratio between the borate derivative and the vinyl alcohol is between 1:1000 and 1:1.

18. The electrochemical cell as recited in claim 4, wherein the crosslinking agent is a Lewis acid, and wherein the polymer is a Lewis base.

19. The electrochemical cell as recited in claim 3, wherein the fabric extends along a longitudinal direction, and wherein the apertures are offset with respect to the longitudinal direction.

20. The electrochemical cell as recited in claim 19, wherein the apertures are elongated and extend longitudinally within the cell.

21. The electrochemical cell as recited in claim 1, wherein the fabric is woven.

22. The electrochemical cell as recited in claim 1, wherein the cathode-facing surface of the fabric is coated with the conformal coating.

23. The electrochemical cell as recited in claim 1, wherein the anode-facing surface of the cathode is coated with the conformal coating.

24. The electrochemical cell as recited in claim 1, wherein the container has an open end, and wherein the fabric defines a portion disposed proximal the open end that is not perforated.

25. A method of preparing a conformal separator for an electrochemical cell defining an enclosure, the steps comprising:
(a) installing a cathode within the enclosure, the cathode presenting an inner surface;
(b) installing a perforated fabric into the enclosure adjacent the inner surface of the cathode, the fabric defining an anode-facing surface and a cathode-facing surface;
(c) crosslinking a polymer with an inorganic crosslinking agent to form a compound; and
(d) applying the compound to at least one of the anode-facing surface, the cathode-facing surface, and the inner cathode surface to provide a separator, wherein the compound prevents electrical contact between the anode and cathode while permitting electrolyte transfer between the anode and cathode.

26. The method as recited in claim 25, further comprising crosslinking the polymer and the agent prior to step (d).

27. The method as recited in claim 25, further comprising applying the polymer and agent individually to the anode-facing surface prior to step (c).

28. The method as recited in claim 25, wherein the fabric defines a plurality of apertures extending therethrough.

29. The method as recited in claim 28, further comprising applying the compound to the cathode at locations aligned with the apertures.

30. The method as recited in claim 25, wherein the crosslinking agent is a borate derivative, and wherein the polymer is a vinyl alcohol.

31. The method as recited in claim 30, wherein the borate derivative is boric acid, and wherein step (c) further comprising adding a base solution to the cathode.

32. The method as recited in claim 31, further comprising wetting the cathode with the base solution prior to step (d).

33. The method as recited in claim 31, further comprising wetting the cathode with the base solution after step (d).

34. The method as recited in claim 25, wherein the fabric is non-woven.

35. A method for reducing entrapped air during fabrication of an electrochemical cell, the steps comprising:
(a) providing a conductive cell container presenting a closed end and an open end, wherein the container presents a radially inner surface;
(b) installing a cathode material into the open end at a location adjacent the radially inner container surface, wherein the cathode presents a radially inner surface;
(c) installing a perforated fabric into the open end at a location adjacent the radially inner cathode surface, wherein the fabric includes a radially inner surface that defines an internal void; and
(d) applying an electrolyte material into the void, whereby the electrolyte migrates through the separator and into the cathode.

36. The method as recited in claim 35, further comprising applying a conformal separator coating to the radially inner fabric surface.

37. The method as recited in claim 36, further comprising applying the conformal separator coating cathode material that is exposed through the perforated fabric.

38. The method as recited in claim 37, wherein the coating comprises a polymeric material.

39. The method as recited in claim 38, wherein the polymeric material is combined with a crosslinking agent.
